(19) United States
(12) Patent Application Publication
(10) Pub. No.: US 2004/0035223 A1
(43) Pub. Date: Feb. 26, 2004

(54) Fish culling system

(76) Inventors: Fred A. Darnell JR., Charlotte, NC (US); Fred A. Darnell SR., Sebring, FL (US)

Correspondence Address: Luke Anderson, McGuireWoods LLP, 2900 Bank of America Corporate Center, 100 North Tryon Street, Charlotte, NC, 28202-4011, US

(21) Appl. No.: 10/454,448

(22) Filed: Jun. 4, 2003

Related U.S. Application Data
(60) Provisional application No. 60/386,691, filed on Jun. 6, 2002.

(51) Int. Cl. G01L 1/22

(52) U.S. Cl. 73/862.474

(57) ABSTRACT

An electronic fish culling system that retains multiple fish weighings corresponding to different fish catches and determines which catches to retain and release. The fish culling system includes an apparatus having a fish container attached to a housing. The housing contains a weight transducer coupled to the fish container that transmits a signal corresponding the weight of the fish in the fish container, a microprocessor assembly coupled to the weight transducer for converting the signal to a corresponding fish weight and storing the fish weight, a display electronically connected to the microprocessor assembly that indicates fish weight and instructions for culling fish, selectors electromechanically connected to the microprocessor assembly for choosing analysis functions of the microprocessor assembly, a power source connected to the microprocessor assembly, and an assortment of clips having different colored tags connected thereto and attachable to the caught fish.

### PRIORITY

This application claims priority from the related co-pending provisional patent application, serial No. 60/386,691, filed on Jun. 6, 2002.

### FIELD OF THE INVENTION

The present invention relates to culling of multiple catches of fish corresponding to a predetermined number of catches to determine a highest gross weight of catches of fish.

### BACKGROUND OF THE INVENTION

Scales for weighing fish have been commonly used incorporating both mechanical and electronic methods. The mechanical methods have used springs and levers, either portable or incorporated into fishing nets. U.S. Pat. Nos. 2,129,469, 2,633,351, 3,082,561, 3,803,742, 4,765,420 and 4,785,897 have mechanical weighing devices attached to fish nets. U.S. Pat. Nos. 3,077,237 and 4,631,851 use mechanical weight and length measuring devices attached to fish nets involving manipulation of the fish or net. Portable electronic scales using capacitance, springs attached to a variable resistor, and strain gages are described, respectively, in U.S. Pat. Nos. 4,936,399, 5,031,710 and 4,660,666. The U.S. Pat. No. 4,660,666 patent references scales using strain gauges.

Many United States State and federal fishing regulations place a restriction on fish size related to length so the anglers must be aware of the length to decide if the fish can be legally retained. It is difficult to measure two parameters such as weight and length simultaneously with any single mechanical apparatus. Furthermore, it is difficult to design a suitable mechanical apparatus that can convert a measured fish parameter such as weight to a desired displayed parameter such as length where the conversion is complex or non-linear, and allow for the selective adjustment of conversion parameters for different fish body types, condition factors, or species.

Mechanical measuring devices attached to nets may generate noise because they contain moving parts such as levers and springs. Audible noise may frighten fish that is undesirable in many fishing situations where a hand-held landing net may be used.

The above-mentioned electronic apparatus patents describe remote devices that require appreciable time for the fish to be handled and measured while out of the water. With these devices the fish must be released from a hook, then handled out of the water, and placed on another hook or similar device for electronic weighing, and then handled again to determine the length of the fish. This process generally requires two hands. This delay and trauma while handling the fish reduces the chance for fish survival if the fish must legally be released in the wild or if it is desired to be release the fish alive for science or fish farming.

U.S. Pat. No. 6,094,996 discloses an apparatus that electronically measures the weight of a fish contained by the apparatus and displays the weight or size of the fish. The U.S. Pat. No. 6,094,996 patent determines the weight of the fish and converts the weight to various size parameters using software coded mathematical formulae dependent on the particular species of fish. However, none of the abovementioned electronic apparatus patents describe an apparatus that provides a system for culling multiple fish.

In competitive fishing environments, multiple fish are caught by individual entrants to determine an ultimate winner based on a largest total weight of the fish caught per entrant. For example, a time limit and a predetermined number of catches are established in a competition where the entrants catch multiple fish in hopes of catching the heaviest fish among the entrants. At the end of the time limit, the entrant with the heaviest total weight of catches within the established number of catches is declared the winner of the competition. During the competition, entrants frequently catch more fish than the established predetermined number catches in hopes of increasing their total weight of catches at the end of the time limit. At the end of the time limit, only the predetermined number of catches will be allowed for determination of the total weight of fish caught.

It is therefore important for the entrants to determine which catches are heaviest to retain such catches and disregard catches that are lighter in weight without exceeding the predetermined number catches allowed. Currently, entrants spend much time separately weighing, measuring and tagging fish to determine which fish to keep or cull. Because there is a time limit for the competition, it is also important to efficiently use time during the process of weighing and culling the caught fish so as to provide more time for the entrants to catch heavier fish. Furthermore, current fish culling techniques requiring reweighing, measuring and tagging of fish add substantial delay to the time the fish are out of water and consequently increase trauma to the fish.

### SUMMARY OF THE INVENTION

The present invention is an electronic fish culling system that retains multiple fish weighings corresponding to different fish catches and determines which catches to retain and release. The fish culling system includes an apparatus having a fish container, such as a net, attached to a housing. The housing contains a weight transducer, such as a strain gauge, coupled to the fish container that transmits a signal corresponding to the weight of the fish in the fish container, a microprocessor assembly coupled to the weight transducer for converting the signal to a corresponding fish weight and storing the fish weight, a display electronically connected to the microprocessor assembly that indicates fish weight and instructions for culling fish, selectors, such as depressable buttons, electromechanically connected to the microprocessor assembly for choosing analysis functions of the microprocessor assembly, a power source connected to the microprocessor assembly, and an assortment of clips having different colored tags connected thereto and attachable to the caught fish.

The housing provides a grasping surface and is preferably formed as a conventional fish net handle. The housing is further sealed to prevent exposure of the microprocessor assembly contained therein. The microprocessor assembly executes preloaded software that indicates via the display an assignment of colored tags to a particular caught fish and advises, using the color of the tag, which of the fish caught should be released in exchange for the most recent fish caught. The selectors provide the user with options for operation including mode of operation, weighing, and incrementing or scrolling up and down selection. The display receives output signals from the microprocessor assembly and generates a visual display of fish weight, minimum weight selected, maximum number of fish kept, and operation status of the fish culling apparatus. The display may be a conventional analog or digital display device. A single display device may be used to display the fish weight and culling instructions in sequential or selective order. Alternatively, multiple displays may be used for simultaneous display of the fish weight and culling instructions.

The apparatus may also contain additional components that allow for automatic taring of the fish container prior to weighing the fish as well as additional components for compensating for temperature influences on the weight transducer, microprocessor assembly, or display devices. Optional apparatus additions such as a light or backlighted display for night fishing may be incorporated. The apparatus may also contain provisions for measuring the length of the fish by including on the net handle or extension of the housing containing the microprocessor, a linear scale marked in English and/or Metric units of measure. Additionally, electrically generated tones or speech commands may be used to represent instructions to the user in addition to or in place of the instructions and information presented by the display(s). The apparatus may allow for multiple anglers. This mode is selected by pressing the MODE selector until the appropriate indication is set for multiple-angler operation. Once set, the unit performs in everyway as described, but for both anglers, keeping individual catch lists and culling instructions for each angler separately.

Initial activation of the apparatus automatically tares the weight of the fish container and indicates readiness for operation. The user may indicate a minimum allowable fish weight and a maximum allowable number of fish kept by selecting the mode of operation using a MODE selector. Once the appropriate mode is selected, the user may indicate a value using an UP selector or DOWN selector. The system returns to a fishing mode if selector activity is idle for a pre-selected time. Once in fishing mode, the fish is positioned into the fish container, and the user presses the weighing selector. The weight of the fish is determined by the microprocessor assembly that in turn indicates instructions on the display to cull the fish, attach an unassigned colored tag to the fish, or cull a previously caught fish by removing its tag and assigning such tag to the newly caught fish. The user can accept or decline the instruction given by the microprocessor by pressing the appropriate selector in the designated manner. The user can obtain a list of all assigned colors and weights and the weight of the total catches by selecting a catch mode using the MODE selector. Changes to the list can be made by selecting an entry for deletion from the list.

The fish culling system allows competitive sport-fish anglers more time fishing by reducing the time spent categorizing and comparing the weights of the catch, while improving the accuracy of determining which fish give the greatest chance for winning a competition. Additionally, the fish culling system reduces stress placed on caught fish by immediately releasing those fish that are lighter than the lightest previously caught fish or lighter than the allowable weight limit, reduces handling and trauma caused by weighing fish multiple times, and returns unallowable fish to the environment sooner.

### OBJECTS OF THE INVENTION

The principal object of the present invention is to provide an electronic fish culling system.

A more particular object of the invention is to provide an electronic fish culling system that weighs and stores the weight of multiple fish catches and determines which catches to cull.

Another object of the invention is to provide an electronic fish culling apparatus that allows a user to retain the heaviest fish catches while releasing the lightest fish catches with a minimal amount of holding time.

Another object of the invention is to provide an electronic fish culling system that reduces stress placed on multiple catches of fish by releasing lighter weighing fish than the lightest previously caught fish or lighter than an allowable weight limit.

### BRIEF DESCRIPTION OF THE DRAWINGS

FIG. 1 is a partial perspective view of a fish culling apparatus in accordance with an embodiment of the present invention.

FIG. 2 is a cross-sectional view of the fish culling apparatus shown in FIG. 1.

FIG. 3 shows clips and tags for use with the fish culling apparatus in accordance with the present invention.

### DETAILED DESCRIPTION OF THE PREFERRED EMBODIMENT

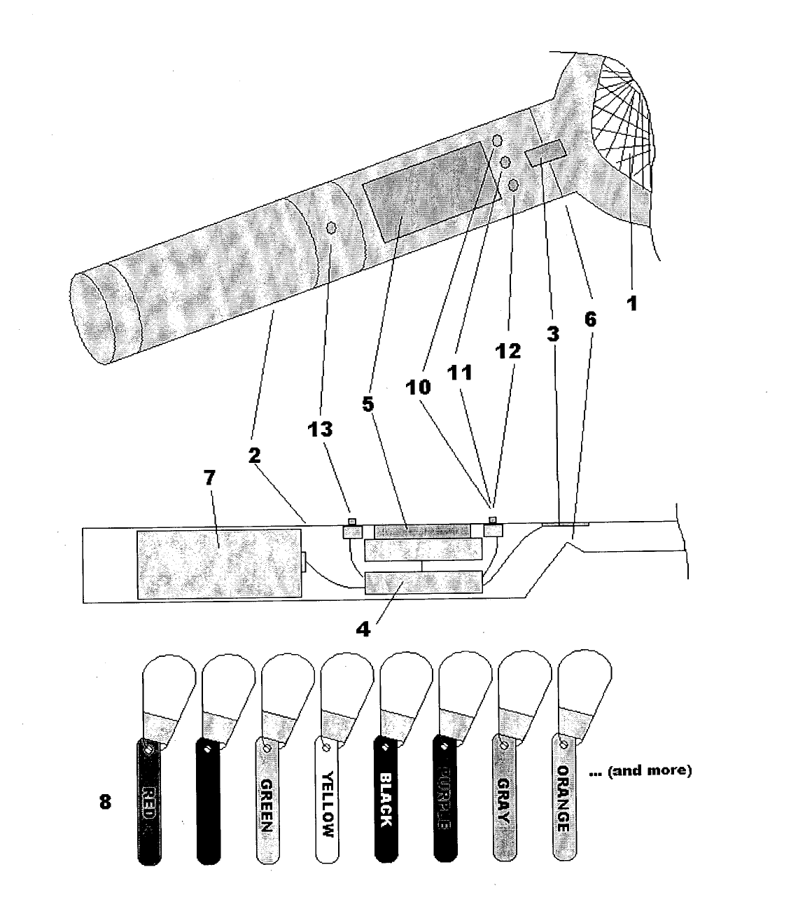

The present invention is an electronic fish culling system that retains multiple fish weighings corresponding to different fish catches and determines which catches to retain and release. FIG. 1 is a partial perspective view of a fish culling apparatus in accordance with an embodiment of the present invention. FIG. 2 is a cross-sectional view of the fish culling apparatus shown in FIG. 1. The fish culling apparatus includes a fish container 1, such as a net, attached to a housing 2. The housing 2 contains a weight transducer 3, such as a strain gauge, coupled to the fish container 1 that transmits a signal corresponding to the weight of the fish in the fish container 1. A microprocessor assembly 4 is coupled to the weight transducer 3 for converting the signal from the weight transducer 3 to a corresponding fish weight and storing the fish weight. A display 5 is electronically connected to the microprocessor assembly 4 that indicates fish weight and instructions for culling fish, as described in greater detail hereinafter. Selectors 10, 11, 12, 13, such as depressable buttons, are electromechanically connected to the microprocessor assembly 4 for choosing analysis functions of the microprocessor assembly, also described in greater detail hereinafter. A power source 7 is connected to the microprocessor assembly 4.

The fish container 1 may be formed into any shape that separates water from a contained fish. This fish container 1 could be a surface member having openings or constructed from pieces of plastic, metal, wood, or fabric that preferably form a net or other fish retaining surface to contain fish while displaying fish size. As best shown in FIG. 2, the electronic components of the fish culling apparatus are contained inside the housing 2, preferably hermetically sealed, and shown to be part of a fish net handle. The housing 2 may also be attached to the net and not be part of any handle. The housing 2 may be any shape to enclose electronic components, constructed from metal, wood, composite, or plastic, and have a removable access section (not shown) of any shape that seals during use. The housing 2 provides a grasping surface and is preferably formed as a conventional fish net handle.

The weight transducer 3 may be selected from spring loaded potentiometers, variable capacitance sensors, strain gauges, piezo crystals, digital signal producers, or load cells measuring pressures, strains or forces caused by fish weight. The weight transducer 3 may be mounted exterior of the sealed housing 2 with signals passing through the hermetic seal. The hermetic seal excludes all moisture from the electronics contained within the housing 2 and permits submersion of the fish culling apparatus under water. For example, mounting strain gauges outside the sealed housing 2 and sealing the electrical connections achieves a hermetic seal.

The microprocessor assembly 4 executes preloaded software that indicates via the display an assignment of colored tags to a particular caught fish and advises, using the color of the tag, which of the fish caught should be released in exchange for the most recent fish caught. The selectors 10, 11, 12, 13 provide the user with options for operation including mode of operation, weighing, and up and down selection. The particular assignment of selectors 10, 11, 12, 13 with options for operation is not critical to the fish culling apparatus.

The microprocessor assembly 4 stores the weights for the selected maximum allowable number of kept fish. Upon weighing of the most immediate fish above the selected maximum allowable number, the microprocessor assembly 4 compares the weight of the most immediate fish with the stored weights to determine with caught fish is to be retained and which to be released. In the event that the weight of the most immediate caught fish is heavier than the lightest weight of the stored fish weights, the microprocessor assembly 4 indicates via the display 4 to cull the least heaviest of the stored fish weights by removing the tag from the fish having the lightest weight and attaching the same to the most immediate caught fish. The microprocessor assembly 5 also stores the weight of the newly caught fish corresponding to the particular tag. In the event that the number of weights stored has not reached the selected maximum allowable number of kept fish, the microprocessor assembly 5 assigns an unassigned clip and colored tag to the most immediate caught fish. In the event that the weight of the most immediate caught fish not within the minimum allowable fish weight, the microprocessor assembly 5 indicates to cull the most immediate caught fish.

Components of the microprocessor assembly 4 for converting and displaying fish size preferably include an Erasable Programmable Read Only Memory (EPROM) and memory, a microcontroller, and a display controller. The EPROM has digital input ports for programming modes of operation into a memory and other inputs using the selectors 10, 11, 12, 13. Other inputs include storing information, or other information. The microcontroller and the display controller direct signals. More than one component in the microprocessor assembly 5 may be combined with another or other components into one component. The EPROM may have a preset memory for specific modes of operation and colors for clips and tags. The installation and use of these components are known in the art of electronics, and alternative configurations using preconfigured memory and microprocessors may be used as is well known to those skilled in the art.

The display 5 receives output signals from the microprocessor assembly 5 and generates a visual display of fish weight, minimum weight selected, maximum number of fish kept, and operation status of the apparatus on a conventional analog or digital display device. The display 5 could be an LED (light emitting diode), LCD (liquid crystal display), analog dial gauge, or any other type of digital or analog display recognized as suitable to display data by those skilled in the art. A single display device may be used to display the fish weight and culling instructions in sequential or selective order. Alternatively, multiple displays may be used for simultaneous display of the fish weight and culling instructions. It is well known to those skilled in the art that information displayed on the display may be presented in varying sizes of text or images and may be provided in a scrollable format.

The apparatus may also contain additional components that allow for automatic taring of the fish container 1 prior to weighing the fish as well as additional components for compensating for temperature influences on the weight transducer 3, microprocessor assembly 5, or display devices. Optional apparatus additions such as a light or backlighted display for night fishing may be incorporated. Through the addition of a minispeaker and corresponding audio generator, both electrically coupled to the microprocessor assembly 5, electrically generated tones or speech commands may be emitted to represent instructions to the user in addition to or in place of the instructions and information presented by the display(s).

FIG. 3 shows clips 14 and tags 15 for use with the fish culling apparatus in accordance with the present invention. The assortment of clips 14 have different colored tags 15 connected thereto and are attachable to the caught fish. Depending on the assignment as determined by the microprocessor assembly 5, the user attaches an appropriate clip and colored tag as indicated by the display 4. In operation, the microprocessor assembly 5 stores the weights of multiple fish catches that meet user selected criteria, such as minimum allowable fish weight and maximum allowable number of kept fish.

Tilt can effect the reliability of a weight measurement. Tilt cannot be eliminated when a weight measurement is taken in a boat due to the boat's rocking motion on the water. Therefore, the apparatus may also contain tilt-sensing means that allows weight measurements to be taken only while the device is held horizontally to the ground. The tilt sensing means may also determine the amount of tilt existing at the time the weight measurement is taken and adjust the measurement according to the amount of tilt. Various tilt sensing means exist and are commonly known in the art, like electronic gyroscopes and leveling devices.

In a preferred embodiment of the operation of the fish culling apparatus, initial activation of the apparatus automatically tares the weight of the fish container 1 and indicates readiness for operation. The user may indicate a minimum allowable fish weight and a maximum allowable number of fish kept by selecting a mode of operation using a MODE selector. Once the appropriate mode is selected, the user may indicate a value using an UP selector or DOWN selector. For example, the user changes the minimum allowable fish weight by pressing the MODE selector successively until a minimum weight prompt is displayed. Then, the user can adjust a minimum weight value by successive presses of the UP selector or DOWN selector. Similarly, the user changes the maximum allowable number of kept fish by pressing the MODE selector successively until a maximum keep prompt is displayed. Then the user can adjust the maximum allowable number value by successive presses of the UP selector or DOWN selector.

The system returns to a fishing mode if selector activity is idle for a pre-selected time. Once in fishing mode, the fish is positioned into the fish container, and the user presses the weighing selector. In a preferred embodiment, weighing of the fish is conducted when the fish container and housing are in a relatively horizontal position. The horizontal position may be determined when the fish container is level about a lateral and horizontal axis of the fish container and housing. The weight of the fish is determined by the microprocessor assembly that in turn indicates instructions on the display to cull the fish, attach an unassigned colored tag to the fish, or cull a previously caught fish by removing its tag and assigning such tag to the newly caught fish. The user can obtain a list of all assigned colors and weights and the weight of the total catches by selecting a catch mode using the MODE selector. Once the catch mode is selected, the assigned colors and corresponding weights are shown on the display. In one embodiment, the assigned colors and corresponding weights may be viewed by scrolling from one assigned color and corresponding weight to the next assigned color and corresponding weight.

### Summary of the Achievement of the Objects of the Invention

From the foregoing, it is readily apparent that I have invented an electronic fish culling system. The present invention provides an electronic fish culling system that weighs and stores the weight of multiple fish catches and determines which catches to cull. The present invention provides an electronic fish culling apparatus that allows a user to retain the heaviest fish catches while releasing the lightest fish catches with a minimal amount of holding time. The present invention provides an electronic fish culling system that reduces stress placed on multiple catches of fish by releasing lighter weighing fish than the lightest previously caught fish or lighter than an allowable weight limit.

It is to be understood that the foregoing description and specific embodiments are merely illustrative of the best mode of the invention and the principles thereof, and that various modifications and additions may be made to the apparatus by those skilled in the art, without departing from the spirit and scope of this invention.

What is claimed is:

1. A fish culling apparatus comprising:
a fish container,
a housing attached to said fish container,
a weight transducer contained within said housing and is coupled to said fish container and a microprocessor assembly for converting a signal from said weight transducer to a corresponding weight and storing said weight, and
a power source connected to said microprocessor.

2. A fish culling apparatus according to claim 1 further comprising a display, said display is electromechanically connected to said microprocessor assembly so it can generate a visual display of said weight.

3. A fish culling apparatus according to claim 2 wherein said display further comprises at least one selector device for choosing the mode of operation for said microprocessor assembly.

4. A fish culling apparatus according to claim 1 further comprising a plurality of detachable clips, wherein each of said plurality of clips indicate a different color, said clips can be detachably connected to fish to identify their weight as recorded in said microprocessor assembly.

5. A fish culling apparatus according to claim 1 further comprising tilt sensing means for determining the fish culling apparatus' degree of tilt to the horizontal, said tilt sensing means are electromechanically connected to said microprocessor assembly.

6. A fish culling apparatus according to claim 1 wherein said microprocessor assembly can generate audible tones instructing a user to either keep or discard a fish.

7. A fish culling apparatus according to claim 1 further comprising a temperature sensing devise, said temperature sensing device is electromechanically connected to said microprocessor assembly so the microprocessor assembly can adjust its weight measurement due to temperature.

8. A fish culling apparatus according to claim 1 further comprising means for culling fish by determining and recording the weight of a fish in said microprocessor assembly and receiving an instruction from said microprocessor assembly to either keep or discard the fish.

9. A fish culling apparatus comprising:
a fish net,
a housing attached to said fish net,
a strain gauge coupled to said fish net,
a microprocessor assembly containing preloaded software that indicates which of the fish caught should be released in exchange for the most recent fish caught, said microprocessor is connected to said strain gauge for determining a weight of a fish in said fish net, and
a power source connected to said microprocessor assembly.

10. A fish culling apparatus according to claim 9 further comprising a display, said display is electromechanically attached to said microprocessor assembly and visually displays the fish's weight and culling instructions.

11. A fish culling apparatus according to claim 9 further comprising a plurality of different colored clips that are detachably connected to retained fish for easy correlation to their weight recorded in said microprocessor assembly.

12. A fish culling apparatus according to claim 9 further comprising a tilt measuring devise for determining the degree of tilt between the fish culling apparatus and the horizontal, said tilt sensing devise is electromechanically connected to said microprocessor assembly.

13. A fish culling apparatus according to claim 9 further comprising a temperature measuring devise for determining the ambient temperature, said temperature measuring devise is electromechanically connected to said microprocessor assembly so the microprocessor assembly can adjust its weight measurement to compensate for the ambient temperature.

14. A fish culling apparatus according to claim 9 further comprising means for culling fish by determining and recording the weight of a fish in said microprocessor assembly and receiving an instruction from said microprocessor assembly to either keep or discard the fish.

15. A method for culling fish comprising of:
Placing a fish in a container, said container is connected to a microprocessor assembly contained in a housing connected to said container;
Taking a weight measurement with a strain gauge that is electromechanically connected to said microprocessor assembly; and
Reading a fish's weight and receiving a culling instruction from a visual display, said visual display is electromechanically connected to said microprocessor assembly and contained in said housing.

16. A method for culling fish according to claim 15 further comprising:
Attaching a removable clip to said fish, wherein each of a plurality of different color clips is used to identify a fish with its recorded weight in said microprocessor assembly.

17. A method for culling fish according to claim 15 wherein said culling instruction consists of an instruction to either keep said fish, discard said fish, or to keep said fish and discard a previously retained fish tagged with said removable clip.
